(19) United States
(12) Patent Application Publication
(10) Pub. No.: US 2014/0370932 A1
(43) Pub. Date: Dec. 18, 2014

(54) System and Method for Initiating an Application on a Handheld Device

(71) Applicant: Michael Eising, Rungsted Kyst (DK)

(72) Inventor: Michael Eising, Rungsted Kyst (DK)

(73) Assignee: ZAFEON LIMITED, Twickenham (GB)

(21) Appl. No.: 13/920,900

(22) Filed: Jun. 18, 2013

(51) Int. Cl. H04M 1/725; H04M 1/02

(52) U.S. Cl. CPC H04M 1/72541; H04M 1/0274
USPC 455/550.1

(57) ABSTRACT

The invention is a system and method for initiating an application installed in a handheld device even when said device is in an idle or standby mode.

The applicant claims priority with provisional application No. 61727176 filed on 16 Nov. 2012.

### TECHNICAL FIELD

The present invention is a system and method for initiating an application on a handheld device even when the device is in idle or standby mode.

### BACKGROUND OF THE INVENTION

Handheld devices using wireless means for communicating over a cellular or wireless Ethernet network now number in the tens of billions worldwide. In addition to common applications, such as telephony and Internet browsing, these devices could be ideal hosts for personal-security applications for alerting first responders in cases of accidents, assaults and any other circumstance requiring rapid response.

For purposes of battery charge preservation most handheld devices will revert to an idle or standby mode after some period of quiescence. Usually, in order to return the device to active mode, and especially to initiate activity by an installed application, one must first change the device's mode from standby to active and go through additional steps to initiate a desired application, such as an email client or Internet browser.

In an emergency situation, though, with the device in someone's pocket, for example, there is likely to be a need to deploy a personal security application quickly and without being able to interact with the device's screen and controls.

The invention disclosed and claimed herein is a system and method for initiating an application with a single control action even in cases where the device is in an idle or standby mode. As such it provides an additional capability when using such applications in that the application may be deployed without removing the device from a pocket or holster, and can be done by feel rather than requiring visual and manual control processes.

### BRIEF SUMMARY OF THE INVENTION

Wireless handheld devices, today, are capable of cellular telephony communications; connectivity with devices; and access to the Internet. As such, one of the uses to which such devices may be applied is personal security. For example, an application that monitors a person's current coordinates and stores a file of personal data that may be crucial to emergency medical procedures makes excellent use of a device's wireless communications and location services.

With most handheld device applications there is no issue other than convenience posed by having to view the screen and proceed through a series of control steps to respond to a text or email, or browse the Internet. But, in an emergency, it will often be necessary to be able to initiate a personal-security application quickly and without having to view the screen.

The invention disclosed and claimed herein provides a system and method for deploying, for example, a personal-security application even in cases where the handheld device is in a pocket or holster. A single button press of an easily located button is all that is required to initiate the activity of an application. In the case of a personal-security application, the single button press can initiate an “alarm” condition where a service provider has information about one's immediate location and can dispatch first responders to that location.

### BRIEF DESCRIPTIONS OF THE DRAWINGS

FIG. 1 depicts a handheld device having a standard I/O interface through which an activation system is able to initiate an application.

FIG. 2 depicts one embodiment of the disclosed system.

FIG. 3 illustrates how the disclosed system from FIG. 2 would interface with a standard I/O interface of a handheld device.

FIG. 4 shows built-in switch buttons on two different typical models of handheld devices whereby with operating system support such built-in buttons can serve as another embodiment of the disclosed activation system.

FIG. 5 shows a flow chart illustrating one embodiment of the disclosed method used to initiate an application.

FIG. 6 shows a flow chart illustrating another embodiment of the disclosed method used to initiate an application.

### DETAILED DESCRIPTION OF THE INVENTION

The following description covers system and method for initiating an application on a handheld device. The activation system and method disclosed are meant to be exemplary and should not be read as limiting the system and method to just those descriptions.

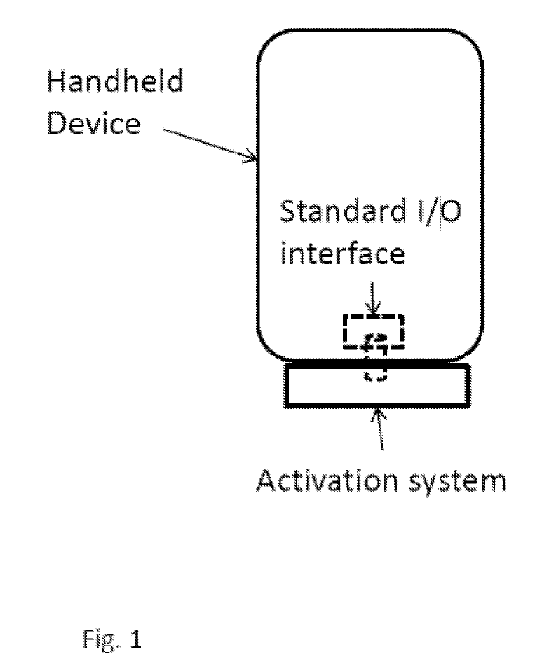

As shown in FIG. 1, commercially available handheld devices, such as so-called “smart phones” provide at least one standard I/O interface used typically for a headphone/microphone headset or some other external accessory device, such as a speaker or speakers and microphone. As shown, an activation device makes use of that I/O interface for initiating an application previously installed on the device.

The handheld device's typical I/O interface, in conjunction with its operating system, can distinguish between at least two types of attached devices (e.g. the headphone/microphone headset or the speakers and microphone). The activation device makes use of that external accessory device detection.

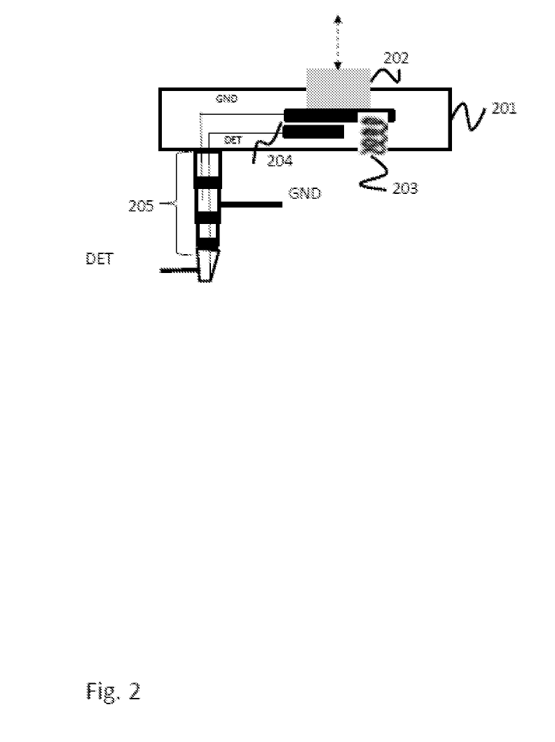

As shown in FIG. 2, one embodiment of an activation system has a housing (201) within which is contained a spring-return, momentary contact, single-pole/single-throw switch (204). One contact of said switch is connected to the tip of a four-contact plug unit that is implemented so as to fit into the I/O interface connector of a device (205). Note that the shape of the tip structure is asymmetrical. The tip connection is denoted as DET for “detected.” The other contact of switch 204 is connected to the ground contact (GND) of the plug-type structure, 205. This contact is denoted as GND for “ground.” When one presses the switch button (202), the contacts (204) will close and DET and GND will be connected to one another. When one removes one's finger from the button, the spring (203) pushes the contacts apart and the connection is broken between DET and GND. The operating system of the handheld device uses the state of DET/GND connection to detect an external device connection and to change its external-device mode status. It should be noted that while this example uses a switch to momentarily connect DET and GND, a handheld device may use two other lines to indicate the presence of an external device and/or to change the handheld device system status. As such, this description is exemplary and should not be read as limiting the invention method to the specific lines DET and GND.

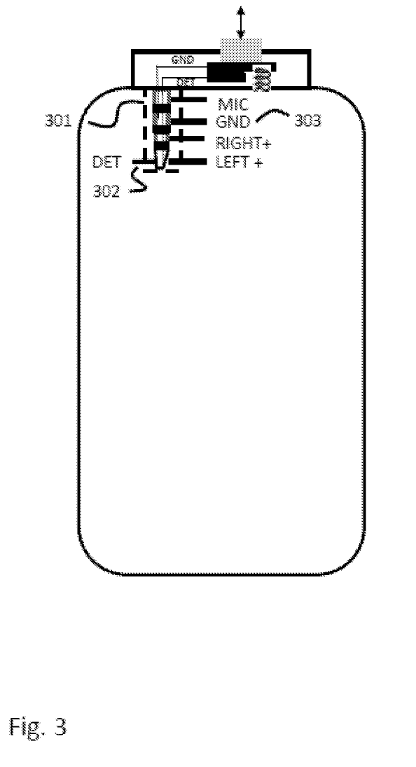

As shown in FIG. 3, the activation system device is connected to the handheld device by inserting the plug-like structure into the handheld device's I/O interface connector (301). The connector 301 has wipers that make contact with the four isolated contacts of the plug-like structure of the activation system. Only the LEFT+ contact, as shown in FIG. 3, does not make contact with the tip. The tip is only sensed by the DET contact of the interface connector, due to the tip's asymmetrical shape, as noted earlier. A different handheld device may require a different orientation of the asymmetrically shaped tip. Or, a different interface may require no tip asymmetry. The description, here, is exemplary and pertains to this particular case. It should not be read as limiting the shape of the tip to only the orientation described. It should also be noted that a different type of I/O interface, having a different form factor and structure will require a different type of mating connector that may have a different contact arrangement. Again, this description is meant to be exemplary and should not limit the system invention to a particular type of mating connector.

When the plug-like structure is inserted in the I/O interface, and the button on the activation system's momentary switch is depressed, the handheld device detects a mode change from speakers and microphone to headset and microphone. That change in I/O mode status can be tracked by an installed application if appropriately coded. The nature of the I/O mode status which is changed may be different than described herein. The change from speakers-and-microphone to headset-and-microphone is meant to be exemplary and should not be read as limiting the I/O status change to only that described herein.

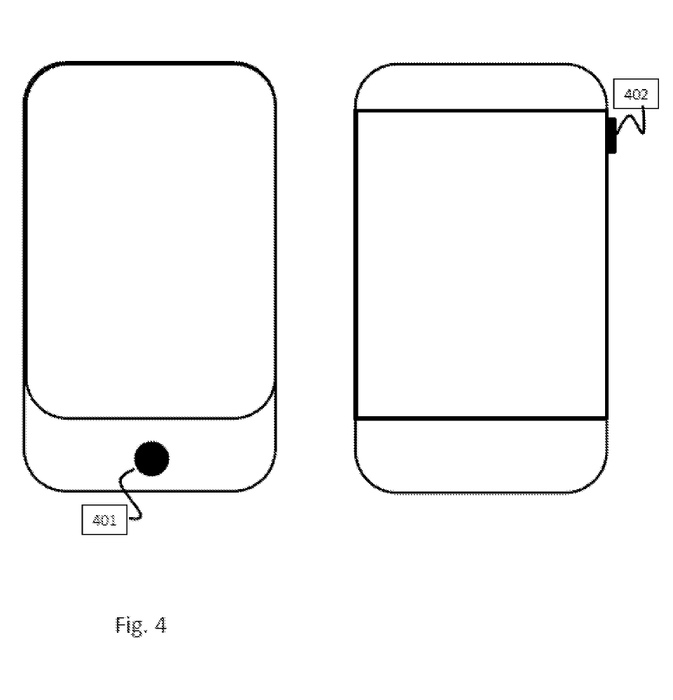

As shown in FIG. 4, all handheld devices have a built-in button and switch, which if supported by its operating system, could serve as another embodiment of the activation system. For example, an installed application, when launched, could be coded to detect the pressing of a built-in button using I/O mode status tracking as is done with the external activation system. The built-in buttons depicted in FIG. 4 are exemplary. Any built-in button on a handheld device located in any position on the device could serve as the activation button.

Once an activation system, whether external or internal, is connected and functioning to cause I/O mode change and I/O mode status change, it can be used to initiate an application.

An aforementioned application must first be installed and configured, such as a personal-security application. Once this has been done, the application is launched and the handheld device can be set to idle or standby mode.

Should the activation system (external or internal) button be depressed for some minimum amount of time, t1, the application will automatically change the handheld device's state to active from idle or standby, and set an alarm state which issues a wireless alert. An alternative method could use two time measurements, t1 and t2, such that an alarm state would be set when the button was held for longer than t1 but released before the time, t2, had elapsed.

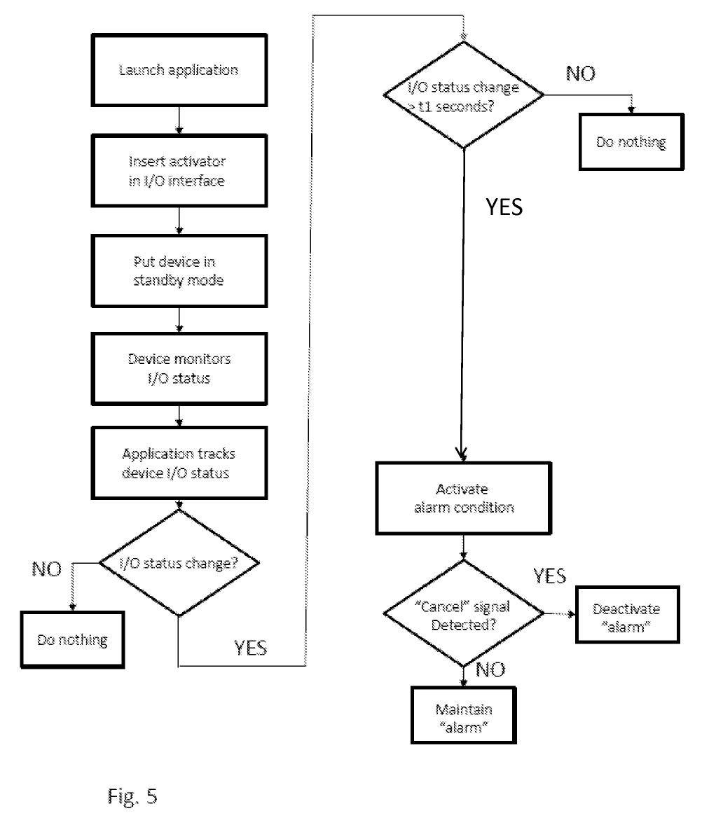

FIG. 5 is one embodiment of the method by which the application working in conjunction with the activation system will carry out its intended function even if the handheld device was in idle or standby mode prior to activation. The value of t1 can be chosen to avoid an inadvertent button press from activating an alarm. For example, t1 could be set to 1.0 second. In that case, one would press the button for more than one second in order to invoke an alarm condition.

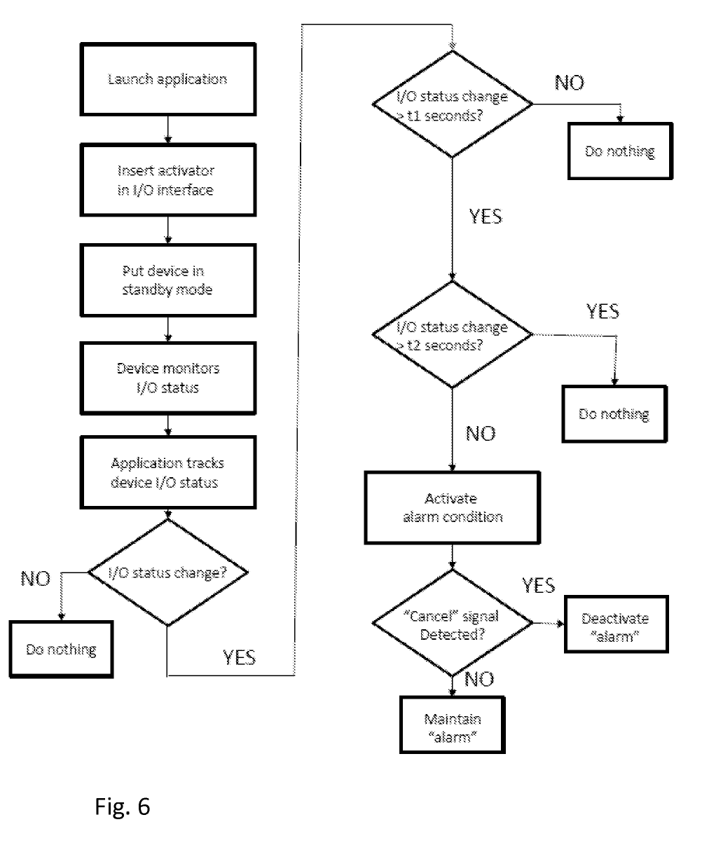

FIG. 6 illustrates a case where two time intervals, t1 and t2 are chosen such that an alarm condition is set only when the button is held for longer than t1 but released before t2 has elapsed. In this case, t1 can 1 second and t2 can be 3 seconds. So an inadvertent short duration button press, of less than one second, would not trigger an alarm, nor would a prolonged button press that exceeded three seconds. The latter could prevent false alarm conditions in a situation where the button is inadvertently pressed and held pressed by an object in a user's pocket.

What is claimed is:

1. A system for initiating an application comprising:
A connector structure whose shape and isolated contact electrodes conform to the number and position of the contacts of an I/O interface connector of a handheld device such that said isolated contact electrodes of said connector device make proper contact with said contacts of said I/O interface connector when said connector is fully engaged with said I/O interface connector;
A single-pole/single-throw, momentary-contact-closure switch;
Said single-pole/single-throw switch connected so as to establish a low-resistance or high-resistance path between two of said isolated contact electrodes of said connector structure;
Said connector structure, when fully engaged with said I/O interface connector, will connect said single-pole/single-throw switch to corresponding said contacts of said I/O interface connector;
A sensing means of said handheld device responsive to said low-resistance path between two of said contacts of said I/O interface connector and operative to indicate a mode A to said handheld device's system software;
Said sensing means of said handheld device responsive to said high-resistance path between said two of said contacts of said I/O interface connector and operative to indicate a mode B to said handheld device's system software;
A means for said handheld device to process said sensing means results and convey the mode status, whether mode A or B, to an application that has been made ready to receive such status indication.

2. A system as in claim 1 further comprising:
Said single pole/single throw switch comprising a movable contact and a stationary contact held apart by a spring-like component, so as to present said high-resistance path between said movable and said stationary contacts;
Said movable contact and said stationary contact and said spring-like component enclosed within a housing such that said stationary contact and said spring-like component are in a fixed position and said movable contact may be moved to a position such that it presents said low-resistance path between said movable and said stationary contacts;
An insulated button, contained within said housing and extending outside said housing, such that when pushed toward said housing it will in turn push said movable contact against said stationary contact so as to present said low-resistance path between said movable and said stationary contacts;
Said insulated button, when no longer pushed, will allow said spring-like component to move said movable contact away from said stationary contact so as to present said high-resistance path between said movable and said stationary contacts.

3. A system for initiating an application comprising:
A built-in switch accessible on the outside of said handheld device;
Said built-in switch, in conjunction with an operating system, operable to detect whether it is being depressed;
Said state of said built-in switch, whether depressed or not depressed, conveyed to an installed application, either directly or by way of changing the status of some other system state which said installed application is able to detect.

4. A method for initiating an application comprising:
Initializing said handheld system;
Launching said application;
Placing said handheld system in an idle or standby mode;
Detecting by said handheld system whether it is in mode A or mode B;
Detecting by said handheld system a change in mode;
Monitoring by said application a change in mode status;
Determining the duration of said change in mode status;
If said change in mode status endures less than t1 seconds, then said application takes no action;
If said change in mode status endures more than t1 seconds, then said application invokes an alarm condition.

5. A method as in claim 4 further comprising:
If said change in mode status endures less than t1 seconds, then said application takes no action;
If said change in mode status endures more than t2 seconds, then said application takes no action;
If said change in mode status endures more than t1 seconds and less than t2 seconds, then said application invokes an alarm condition.

6. A method as in claim 4 further comprising:
Detecting by said application the occurrence of a cancellation command;
If said cancellation command is detected, then said application ends the alarm condition;
If said cancellation command is not detected, then said application maintains the alarm condition.

7. A method as in claim 5 further comprising:
Detecting by said application the occurrence of a cancellation command;
If said cancellation command is detected, then said application ends the alarm condition;
If said cancellation command is not detected, then said application maintains the alarm condition.
